(19) United States
(12) Patent Application Publication
(10) Pub. No.: US 2007/0273481 A1
(43) Pub. Date: Nov. 29, 2007

(54) RFID tag with programmable read range

(75) Inventor: Mohammad Soleimani, Gaithersburg, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/440,094

(22) Filed: May 25, 2006

(51) Int. Cl. H04Q 5/22

(52) U.S. Cl. 340/10.1; 340/572.1; 340/10.33; 340/10.41

(57) ABSTRACT

A system and method in a radio frequency identification (RFID) tag for responding to RFID reader communication signals is described. A strength of a signal from a reader is measured. A RFID read signal is received from the reader. A response to the read signal is enabled based on the measured strength.

### CROSS REFERENCE TO RELATED APPLICATIONS

The following application of common assignee is related to the present application, and is incorporated by reference herein in its entirety:

“RFID Tag Receive Signal Strength Indicator,” Atty. Dkt. No. 2319.0600000, U.S. application Ser. No. 11/394,164, filed Mar. 31, 2006, now pending.

### BACKGROUND OF THE INVENTION

1. Field of the Invention

The invention relates to radio frequency identification (RFID) technology, and in particular, to enabling RFID tags to respond to RFID communication signals based on received signal strength.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Because the reader “interrogates” RFID tags, and receives signals back from the tags in response to the interrogation, the reader is sometimes termed as “reader interrogator” or simply “interrogator.”

With the maturation of RFID technology, efficient communication between tags and interrogators has become a key enabler in supply chain management, especially in manufacturing, shipping, and retail industries, as well as in building security installations, healthcare facilities, libraries, airports, warehouses etc.

Currently, RFID tags, particularly tags capable of communicating at ultra high frequencies (UHF), can be read from a long distance. UHF tags typically have read ranges that greatly exceed those of high frequency tags. Although this may be considered advantageous in some situations, long-range communication capability may be undesirable in other situations. For example, long range communication capability in tags can lead to security concerns, where illicit readers may be able to read the tags from far away. For instance, when a tag is embedded in a passport, it may be desirable for it to be read only at relatively short distances (e.g., by an immigration agent), and undesirable for it to be readable at long range.

Thus, what is needed are ways to prevent reads of tags from long ranges, and to improve security during communications with tags.

### BRIEF SUMMARY OF THE INVENTION

Methods, systems, and apparatuses for controlling responses of tags to read signals are described. According to aspects of the present invention, RFID tags are enabled to respond to RFID communication signals based on received signal strength.

In a first aspect, a system and method in a radio frequency identification (RFID) tag for responding to RFID reader communication signals is described. A strength of a signal from a reader is measured. A RFID communication signal is received from the reader, such as a read or interrogation signal. A response to the read signal is enabled based on the measured strength.

In a further aspect, if the response is enabled, a data object is selected, and a response to the read signal is transmitted that includes the data object.

In a further aspect, the data object may be selected based on the measured signal strength. For example, the data object may be selected from a plurality of data objects based on the measured signal strength.

In a still further aspect, a duration of time over which the measured strength is greater than a threshold signal strength value is measured. The response to the read signal is enabled if the measured duration of time is greater than a threshold time value.

In a still further aspect, if the response is not enabled, a response to the read signal is inhibited.

In another aspect of the present invention, an RFID tag is described. The tag includes an antenna, a signal strength monitor module configured to measure a strength of a signal received at the antenna from a reader, and a response enable module configured to enable a response to a read signal based on the measured strength.

In a further aspect, the tag further includes a demodulator coupled to the antenna and configured to receive a RFID read signal from the reader, and a modulator coupled to the antenna. The modulator is configured to modulate a response to the read signal onto a radio frequency signal if enabled by the response enable module.

In a further aspect, the response enable module is configured to inhibit a response to the read signal based on the measured strength.

In a still further aspect, the tag further includes a timer module configured to measure a duration of time over which the measured strength is greater than a stored threshold signal strength value. The response enable module is configured to enable a response to the read signal if the measured duration of time is greater than a stored threshold time value.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of an RFID reader.

FIG. 3 shows a block diagram of an example radio frequency identification (RFID) tag.

FIG. 4 shows a block diagram of a RFID tag having a receive signal strength monitor, according to an example embodiment of the present invention.

FIG. 5A shows a flowchart for a reader to communicate with a tag to monitor a reader transmitted signal, according to an example embodiment of the present invention.

FIG. 5B shows a flowchart for a tag to monitor a reader transmitted signal, according to an example embodiment of the present invention.

FIG. 6 shows a block diagram of functionality in a tag for enabling a response, according to an example embodiment of the present invention.

FIGS. 7A-7D show flowcharts for enabling a response in a tag, according to example embodiments of the present invention.

FIG. 8 shows example data objects stored in a memory, according to an example embodiment of the present invention.

FIGS. 9 and 10 show example response enable modules, according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

Methods, systems, and apparatuses for RFID devices are described herein. In particular, methods, systems, and apparatuses for controlling tag responses to RFID communication signals are described.

In an embodiment, RFID tags monitor a strength of signals transmitted by RFID readers. For example, a reader transmits a signal to a tag to power the tag. The tag measures a strength of the received signal. The reader transmits a read signal to the tag. The tag responds to the read signal if the measured strength of the received signal meets desired criteria.

Embodiments of the present invention aid in overcoming security issues, enabling tags to respond to read signals transmitted by readers within a desired communication range. The range of the reader transmitting the read signal correlates to strength (e.g., power level) of the power signal provided by the reader. Thus, if the measured signal strength is sufficient, and/or satisfies other criteria, the tag responds to the read signal. The particular data transmitted by the tag may depend on a particular measured signal strength.

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System Embodiment

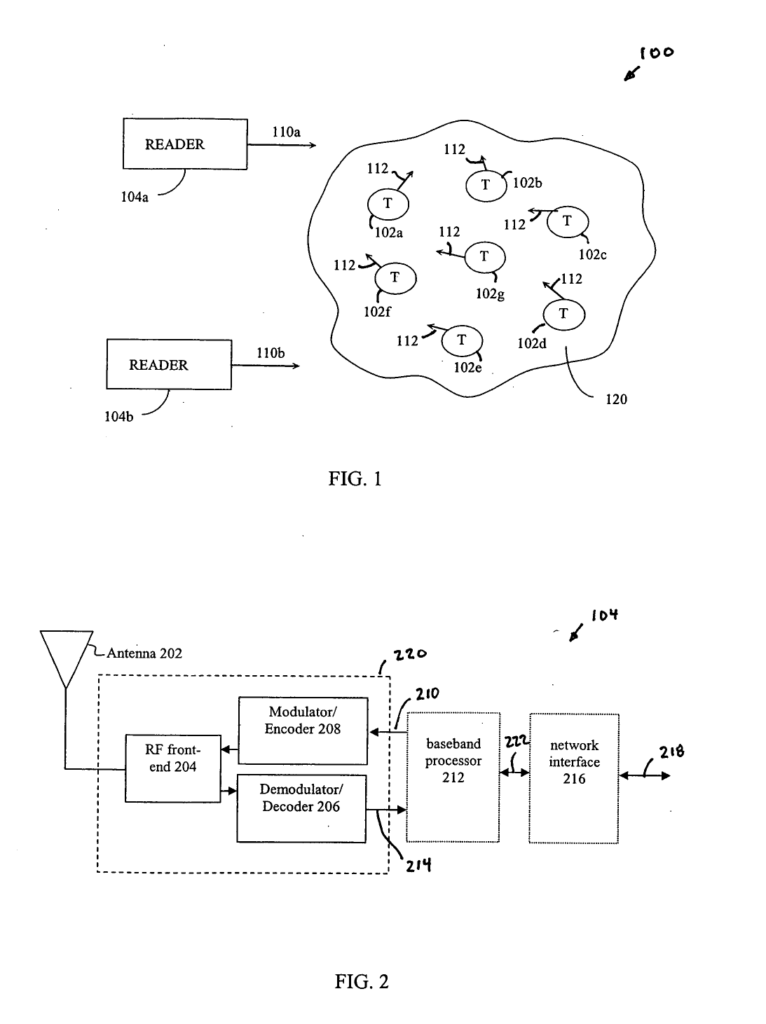

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110a having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, such as one of pulse-interval encoding (PIE), FM0, or Miller encoding formats, modulates the encoded signal, and outputs the modulated encoded interrogation signal to RF front-end 204.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214.

The configuration of transceiver 220 shown in FIG. 2 is provided for purposes of illustration, and is not intended to be limiting. Transceiver 220 may be configured in numerous ways to modulate, transmit, receive, and demodulate RFID communication signals, as would be known to persons skilled in the relevant art(s).

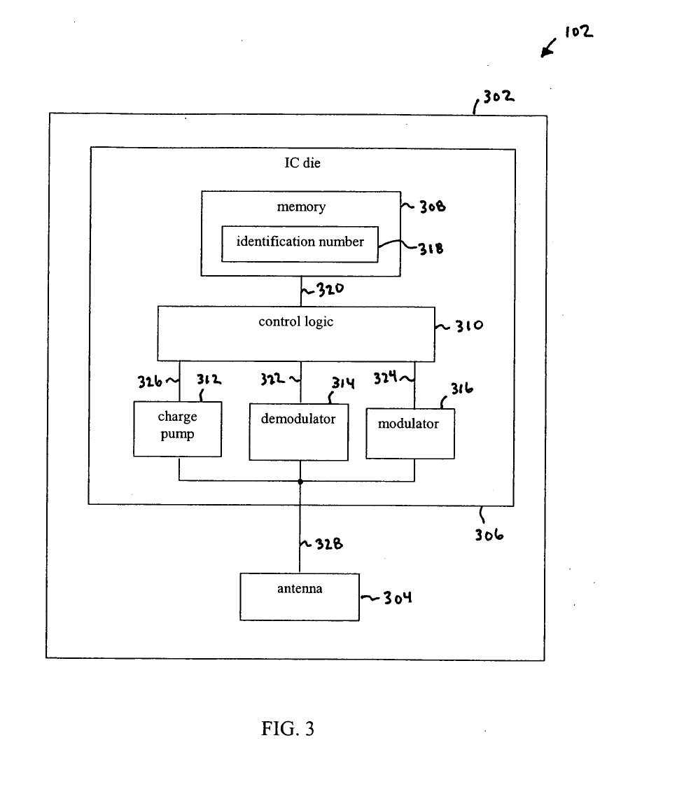

The present invention is applicable to any type of RFID tag. FIG. 3 shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328.

Memory 308 is typically a non-volatile memory, but can alternatively be a volatile memory, such as a DRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Charge pump 312 (or other type of power generation module) is coupled to antenna 304 by antenna signal 328. Charge pump 312 receives a radio frequency communication signal (e.g., a carrier signal transmitted by reader 104) from antenna 304, and generates a direct current (DC) voltage level that is output on tag power signal 326. Tag power signal 326 is used to power circuits of IC die 306, including control logic 320.

Charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag, as would be known to persons skilled in the relevant art(s), may be present. Further description of charge pump 312 is provided below.

It will be recognized by persons skilled in the relevant art(s) that tag 102 may include any number of modulators, demodulators, charge pumps, and antennas. Tag 102 may additionally include further elements, including an impedance matching network and/or other circuitry. Furthermore, although tag 102 is shown in FIG. 3 as a passive tag, tag 102 may alternatively be an active tag (e.g., powered by battery).

As further described below, according to embodiments of the present invention, a tag is enabled to respond to reader communications based on a strength of a signal received from a reader. Embodiments of the present invention are described in further detail below. Such embodiments may be implemented in the environments, readers, and tags described above, and/or in alternative environments and alternative RFID devices.

### Example Signal Monitor Embodiments

Embodiments are described herein for using tags to monitor reader transmitted signals. These embodiments can be implemented anywhere that readers and tags are used. For example, embodiments can be implemented in a commercial or industrial environment, such as in a warehouse, a factory, a business, or store, and in a military or other non-commercial environment.

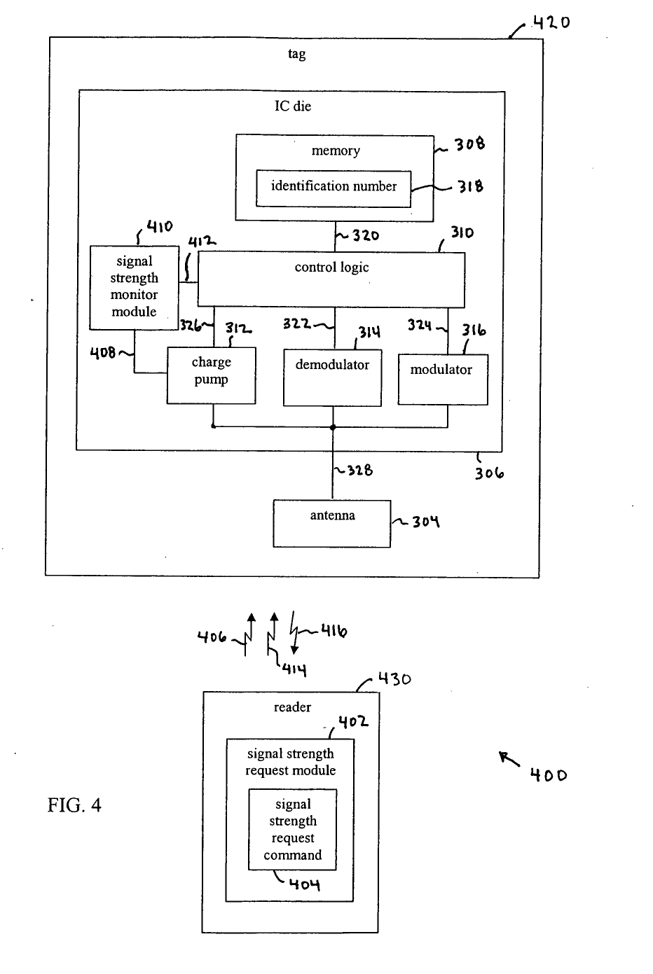

FIG. 4 shows a RFID communications system 400, with reader signal monitoring capability, according to an embodiment of the present invention. As shown in FIG. 4, system 400 includes a tag 420 and a reader 430. In an embodiment, reader 430 communicates with tag 420 to request a signal strength indication from tag 420. Tag 420 provides the signal strength indication to reader 430. Further example description of tag 420 and reader 430, and an operational description of system 400, is provided in the following subsections.

### Example Reader Embodiments

Reader 430 may be configured similarly to any type of RFID reader, including the embodiments of reader 104 shown in FIGS. 1 and 2, and further described above. Reader 430 further includes a signal strength request module 402. Signal strength request module 402 includes a signal strength request command 404. Signal strength request module 402 is shown internal to reader 430 in FIG. 4, but may alternatively be external to reader 430 (e.g., located in a remote computer system that communicates with reader 430).

Signal strength request module 402 is configured to communicate (e.g., using the receiver/transmitter functionality of reader 104, such as described above) with a tag, such as tag 420, to request that the tag provide an indication to reader 430 of a strength of a signal transmitted by reader 430. Signal strength request module 402 may include any hardware, software, firmware, or any combination thereof, needed to perform its functions.

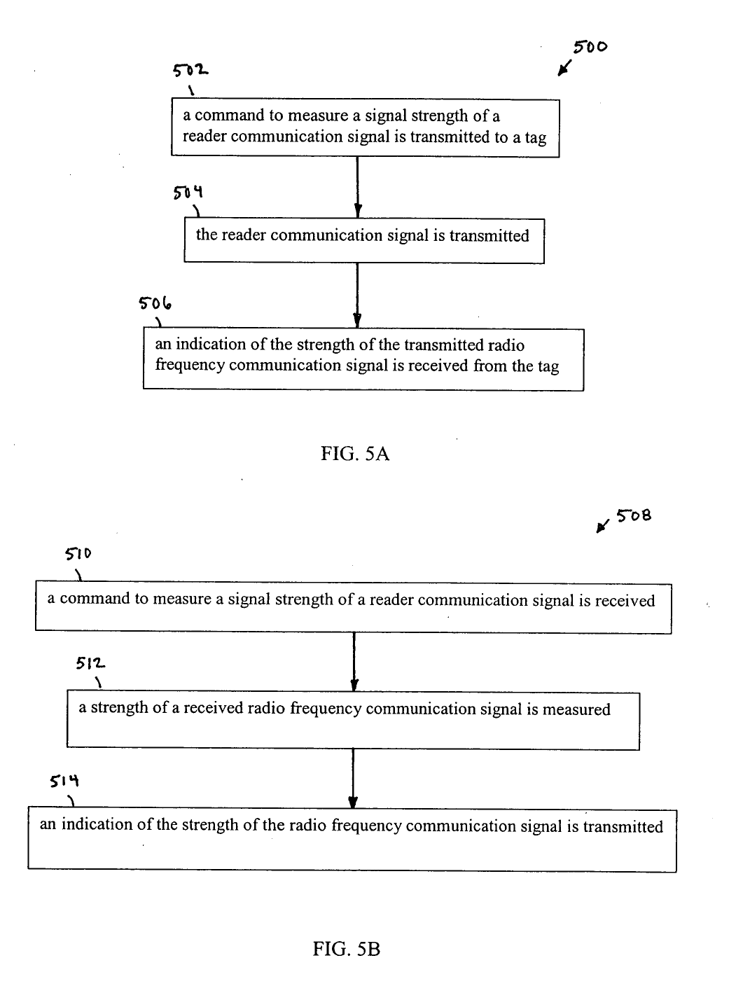

FIG. 5A shows a flowchart 500 providing example steps for reader 430 to communicate with a tag according to signal strength request module 402. Other structural and operational embodiments will be apparent to persons skilled in the relevant art(s) based on the following discussion. As described below, the steps shown in FIG. 5 do not necessarily have to occur in the order shown, and in an embodiment, steps 502 and 504 may overlap.

Flowchart 500 begins with step 502. In step 502, a command to measure a signal strength of a reader communication signal is transmitted to a tag. For example, the command is signal strength request command 404 shown in FIG. 4, which may be stored in signal strength request module 402. Signal strength request command 404 may be configured in any manner, and in accordance with any RFID communications protocol mentioned elsewhere herein, or otherwise known by persons skilled in the relevant art(s). For example, signal strength request command 404 may be formatted in accordance with the EPC Gen 2 RFID protocol. In such an embodiment, signal strength request command 404 may be a CUSTOM command. Furthermore, signal strength request command 404 may be configured to be directed to a single tag, or to a group of tags, even including all tags in communications range of reader 430.

In an embodiment, signal strength request command 404 may include one or more parameters. For example, verify command 404 may include a timing parameter. The timing parameter may be used in the targeted tag to dictate a time (e.g., measured from receipt of command 404) at which the tag should perform a measurement of signal strength. Alternatively, signal strength request command 404 does not include a parameter, and merely instructs one or more tags to respond with a signal strength indication.

Signal strength request command 404 is transmitted in signal strength request signal 406, shown in FIG. 4. The generation and transmission of signal strength request signal 406 may be initiated by a user of reader 430 (e.g., by a button or trigger), a mechanism internal to reader 430, by an external computer system that communicates with reader 430, or by other mechanism.

In step 504, the reader communication signal is transmitted. For example, the reader communication signal is reader communication signal 414 shown in FIG. 4. Thus, in an embodiment, tag 420 performs a signal strength measurement of reader communication signal 414, which is a separate signal from the signal strength request signal 406, previously sent. Alternatively, in an embodiment, it is not required to transmit a separate reader communication signal for measurement by tag 420. For example, tag 420 may be performing signal strength measurements on a continuous basis, and when signal strength request command 404 is received, tag 420 merely responds with its most recent signal strength measurement. In another embodiment, tag 420 performs a signal strength measurement on signal strength request signal 406, which includes signal strength request command 404. Thus, in such an embodiment, steps 502 and 504 may be overlapping, referring to the same transmitted signal.

In step 506, an indication of the strength of the transmitted radio frequency communication signal is received from the tag. For example, the received signal is signal strength response signal 416, which is received from tag 420 in FIG. 4. Thus, reader 430 receives an indication of the strength of a signal transmitted by reader 430 (e.g., signal strength request signal 406 or reader communication signal 414), and reader 430 and/or a user of reader 430 can act accordingly.

### Example Tag Embodiments

As shown in FIG. 4, tag 420 is configured similar to the embodiment of FIG. 3, and further includes a signal strength monitor module 410. Signal strength monitor module 410 receives charge pump output signal 408, and outputs a signal strength indication 412. Signal strength monitor module 410 is configured to monitor a strength of communications signals received from readers. Signal strength monitor module 410 may monitor received signals on a periodic basis, or upon occurrence of an event, such as receipt of signal strength request command 404 from reader 430. Signal strength monitor module 410 generates a signal strength indication to be transmitted to reader 430. Signal strength monitor module 410 may include any hardware, software, firmware, or any combination thereof, needed to perform its functions.

In an embodiment, such as shown in FIG. 4, signal strength monitor module 410 may be coupled indirectly to antenna 304, such as through charge pump 312, and thus may receive a radio frequency communication signal indirectly from antenna 304. In an alternative embodiment, signal strength monitor module 410 may be directly coupled to antenna signal 328 of antenna 304, and thus may receive a radio frequency communication signal directly from antenna 304.

FIG. 5B shows a flowchart 508 providing example steps in a tag for providing a signal strength indication to a reader. Other structural and operational embodiments will be apparent to persons skilled in the relevant art(s) based on the following discussion.

Flowchart 508 begins with step 510. In step 510, a command to measure a signal strength of a reader communication signal is received. For example, antenna 304 of tag 420 receives signal strength request command 404 from reader 430 in signal strength request signal 406. For example, demodulator 314 and control logic 310 may be used to recover signal strength request command 404 from signal strength request signal 406. Tag 420 may communicate according to any communications protocol mentioned herein or otherwise known.

In step 512, a strength of a received radio frequency communication signal is measured. For example, in an embodiment, receipt of signal strength request command 404 causes signal strength monitor module 410 to measure a strength of a received radio frequency communication signal (e.g., signal strength request signal 406 or reader communication signal 414). As described above, in an embodiment, signal strength request command 404 may be continuously measuring strengths of received reader signals. Thus, step 512 may occur before, during, or after step 510, depending on the particular implementation. In an embodiment, a measured signal strength may be stored in memory 308.

Furthermore, when signal strength request command 404 includes a timing parameter, signal strength monitor module 410 may include a timing module to process the timing parameter, to determine a time when a signal strength measurement should be executed. Signal strength monitor module 410 may include further modules, as needed, to process further parameters of a signal strength request command 404.

Signal strength monitor module 410 can be configured to measure signal strengths in a variety of ways, several examples of which are illustrated in detail further below.

In step 514 of FIG. 5B, an indication of the strength of the radio frequency communication signal is transmitted. For example tag 420 may transmit signal strength response signal 416, including the signal strength indication.

For further description regarding example signal strength monitor modules, refer to pending U.S. application Ser. No. 11/394,164, filed Mar. 31, 2006, titled “RFID Tag Receive Signal Strength Indicator,” which is incorporated herein by reference in its entirety.

### Example Tag Response Enable Embodiments

Example embodiments that enable tags to response to reader communication signals based on signal strength are described as follows. These examples are provided for illustrative purposes, and are not limiting. The examples described herein may be adapted to any type of tag. Further structural and operational embodiments, including modifications/alterations, will become apparent to persons skilled in the relevant art(s) from the teachings herein.

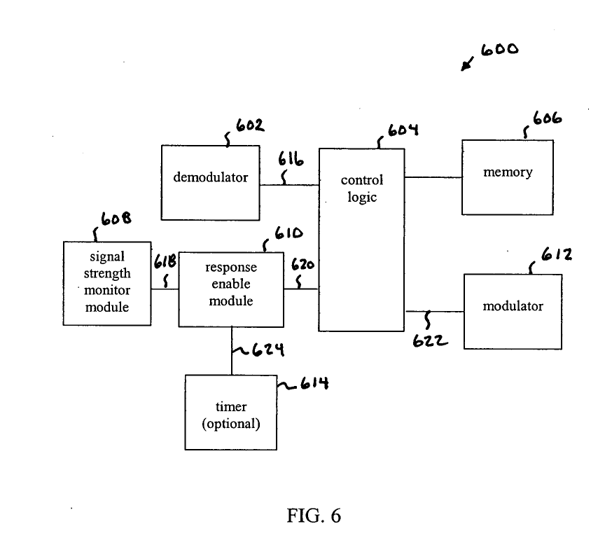

FIG. 6 shows a block diagram of a portion of a RFID tag 600, according to an example embodiment of the present invention. Tag 600 includes a demodulator 602, a control logic 604, a memory 606, a signal strength monitor module 608, a response enable module 610, a modulator 612, and an optional timer 614. These elements of tag 600 may be implemented in an integrated circuit die/chip of tag 600, in another electrical circuit implementation, or any other implementation of hardware, software, firmware, or combination thereof, of tag 600. Elements of tag 600 shown in FIG. 6 that have the same name as elements shown in FIG. 4 are functionally similar to those elements of FIG. 4, and thus for reasons of brevity, all functional aspects of these elements of tag 600 are not necessarily repeated below.

In the embodiment of FIG. 6, signal strength monitor module 608 is configured to measure a strength of a signal received from a reader. Demodulator 602 is configured to demodulate a RFID read signal transmitted by the reader and received by an antenna (not shown in FIG. 6) of tag 600, and outputs a demodulated reader signal 616. Control logic 604 receives demodulated reader signal 616, and processes an instruction/data of demodulated signal 616. For example, control logic 604 determines what type of response, if any, for tag 600 is necessary due to the instruction/data of demodulated reader signal 616. Control logic 604 may include a processor (and software/firmware), a state machine, and/or other logic to determine how to respond to the received read signal.

Response enable module 610 is configured to enable a response to the read signal received from the reader, based on the signal strength measured by signal strength monitor module 608. Response enable module 610 receives signal strength indication 618 from signal strength monitor module 608. Response enable module 610 generates a response enable signal 620 indicating whether tag 600 can respond to the read signal. In an embodiment, response enable signal 610 has a first state (e.g., a “1”) to indicated that a response to the read signal is enabled, and a second state (e.g., a “0”) to indicate that a response to the read signal is not enabled (is inhibited). In other embodiments, response enable signal 610 can have more than two states (e.g., can be a multi-bit value in a digital embodiment) when a response is enabled, such that more than one response is possible (depending on the particular level of signal strength indication 618 within an acceptable, enabling range). Depending on the particular configuration of control logic 604, response enable signal 610 can be an analog or digital signal.

Control logic 604 receives response enable signal 610. If response enable signal 610 indicates that a response is enabled, control logic 604 determines data to use to respond to the read signal (or other reader signal). For instance, control logic 604 may retrieve response data from memory 606 (e.g., an identification number, sensor data, etc.). Control logic 604 provides the output data to modulator 600 on output signal 622 if response enable signal 610 indicates a response is enabled. Modulator 600 modulates the output data into a tag response that is transmitted by an antenna of tag 600.

Timer 614 is optionally present. Timer 614 is configured to measure a duration of time over which a signal strength measured by signal strength monitor module 614 is at a desired level. Response enable module 610 is configured to enable a response to the read signal if the measured duration of time is greater than a predetermined threshold time value. Response enable module 610 communicates with timer 614 over timer signal 624. For example, response enable module 610 may send timer start and timer end signals over timer signal 624 to timer 614. Timer 614 may provide response enable module 610 with a periodic time signal, an indication of an elapsed time, or other time-related signal over timer signal 624. Timer 614 may include a counter, monostable multivibrator circuit, and/or other logic to track time.

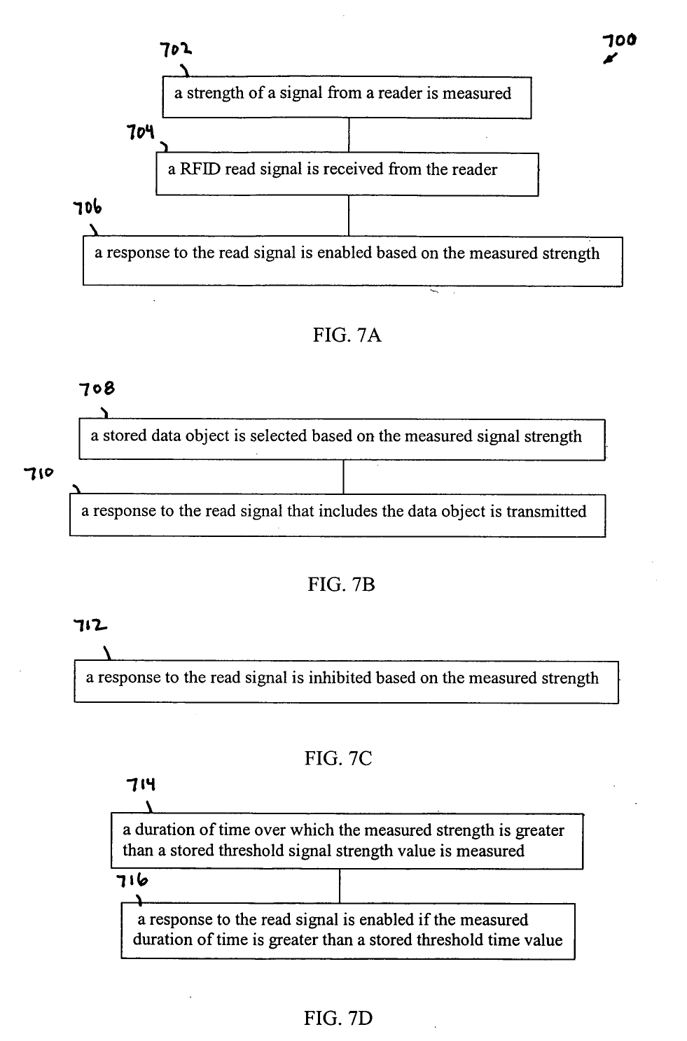

FIG. 7A shows a flowchart 700 providing example steps in a tag for responding to reader communication signals, according to an embodiment of the present invention. Other structural and operational embodiments will be apparent to persons skilled in the relevant art(s) based on the following discussion.

Flowchart 700 begins with step 702. In step 702, a strength of a signal from a reader is measured. For example, as described above, signal strength monitor module 608 measures a strength of a signal received from a reader, such as a RF signal transmitted by the reader to provide power to tags (e.g., a carrier wave/frequency).

In step 704, a RFID read signal is received from the reader. For example, a read signal, such as interrogation signal 110a transmitted by reader 104a, shown in FIG. 1, is received from a reader.

In step 706, a response to the read signal is enabled based on the measured strength. For example, as described above, response enable module 610 determines whether a response to the read signal should be enabled, based on a strength of the signal measured by signal strength monitor module 608.

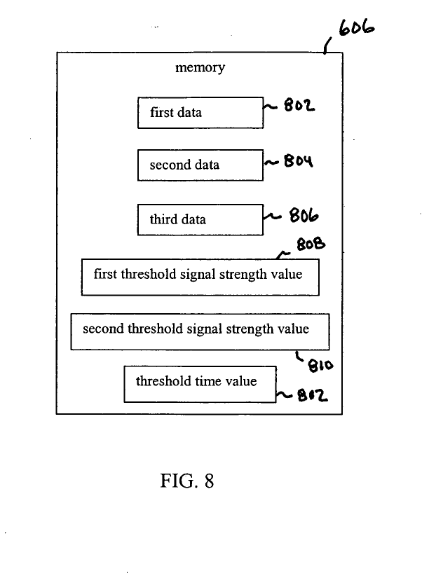

For example, in an embodiment, a response to the read signal is enabled if the measured signal strength is greater than a threshold signal strength value. In such an embodiment, response enable module 610 may compare the measured signal strength received on signal strength indication 618 to a stored threshold signal strength value. FIG. 8 shows memory 606 storing example data, according to an example embodiment of the present invention. As shown in FIG. 8, memory 606 stores a first threshold signal strength value 808. In an embodiment, response enable module 610 compares the measured signal strength to first threshold signal strength value 808. If the measured signal strength is greater than first threshold signal strength value 808, a response is enabled. If the measured signal strength is less than first threshold signal strength value 808, a response is not enabled.

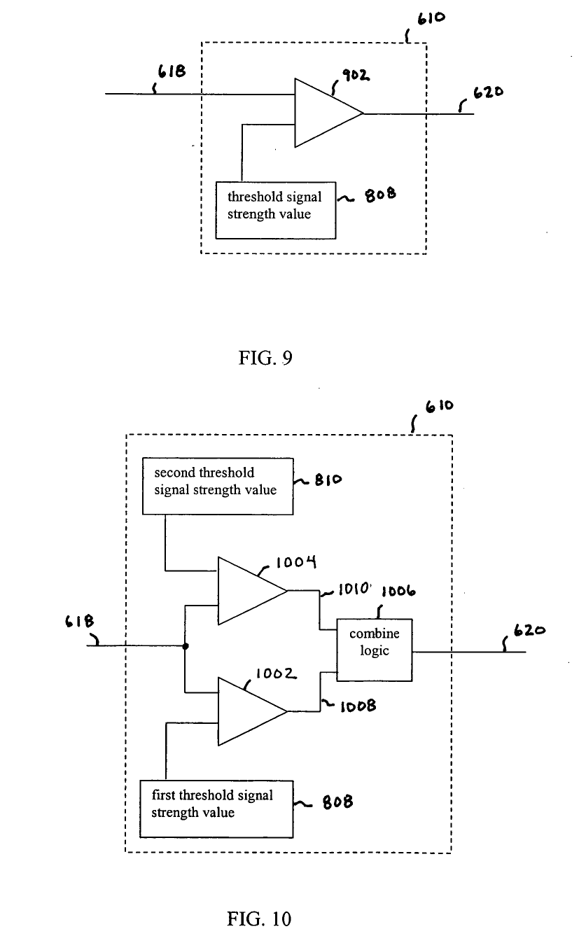

FIG. 9 shows an example implementation of response enable module 610, according to an embodiment of the present invention. As shown in FIG. 9, response enable module 610 includes a comparator 902. As shown in FIG. 9, comparator 902 compares signal strength indication 618 to threshold signal strength value 808. Comparator 902 outputs response enable signal 620. In the current example, if signal strength indication 618 is greater than first threshold signal strength value 808, response enable signal 620 provides an indication that a response to the read signal is enabled (e.g., response enable signal 620 is a “1” logical value). If signal strength indication 618 is less than first threshold signal strength value 808, response enable signal 620 provides an indication that a response to the read signal is not enabled (e.g., response enable signal 620 is a “0” logical value).

In another embodiment, a response to the read signal is enabled if the measured signal strength is less than a threshold signal strength value. In such an embodiment, response enable module 610 may compare the measured signal strength received on signal strength indication 618 to first threshold signal strength value 808. If the measured signal strength is less than first threshold signal strength value 808, a response is enabled. If the measured signal strength is greater than first threshold signal strength value 808, a response is not enabled. For example, comparator 902 of FIG. 9 can be reconfigured to make this determination (e.g., the two signals input to comparator 902 shown in FIG. 9 could be switched), as would be understood by persons skilled in the relevant art(s).

In another embodiment, a response to the read signal is enabled if the measured signal strength is within a particular range. In such an embodiment, response enable module 610 may compare the measured signal strength received on signal strength indication 618 to a pair of threshold signal strength values. For example, as shown in FIG. 8, memory 606 stores a second threshold signal strength value 810. In the current example, second threshold signal strength value 810 has a value that is greater than that of first threshold signal strength value 808. If the measured signal strength is greater than first threshold signal strength value 808, and less than second threshold signal strength value 810, a response is enabled. If the measured signal strength is less than first threshold signal strength value 808, or greater than second threshold signal strength value 810, a response is not enabled.

FIG. 10 shows an example implementation for response enable module 610, according to an embodiment of the present invention. Response enable module 610 of FIG. 10 can be used to determine whether a measured signal strength is within a range. As shown in FIG. 10, response enable module 610 includes first and second comparators 1002 and 1004. As shown in FIG. 10, first comparator 1002 compares signal strength indication 618 to first threshold signal strength value 808. Comparator 1002 outputs a first enable signal 1008. If signal strength indication 618 is greater than first threshold signal strength value 808, first comparator 1002 outputs an indication of this on first enable signal 1008 (e.g., a “1” logical value). Second comparator 1004 compares signal strength indication 618 to second threshold signal strength value 810. Second comparator 1004 outputs a second enable signal 1010. If signal strength indication 618 is less than second threshold signal strength value 810, second comparator 1004 outputs an indication of this on second enable signal 1010 (e.g., a “1” logical value).

A combine logic 1006 receives and combines first and second enable signals 1008 and 1010 to determine whether signal strength indication 618 has a value between first and second threshold signal strength values 808 and 810. In the current example, if signal strength indication 618 is greater than first threshold signal strength value 808, and less than second threshold signal strength value 810, combine logic 1006 generates response enable signal 620 to provide an indication that a response to the read signal is enabled (e.g., response enable signal 620 is a “1” logical value). If signal strength indication 618 is less than first threshold signal strength value 808, or greater than second threshold signal strength value 810, combine logic 1006 generates response enable signal 620 to provide an indication that a response to the read signal is not enabled (e.g., response enable signal 620 is a “0” logical value).

For example, if as described above, first and second enable signals 1008 and 1010 are each “1” logical values when signal strength indication 618 is respectively greater than and less than the first and second threshold signal strength values 808 and 810, combine logic 1006 may include an “AND” logic gate to generate response enable signal 620 as a “1” logic value for this condition (within the range), and as a “0” logic value for other conditions (outside of range).

FIG. 7B shows additional steps for flowchart 700 when a response is enabled by response enable module 610, according to an example embodiment of the present invention. In step 708 of FIG. 7B, a stored data object is selected based on the measured signal strength. In this example, control logic 604 determines an appropriate response to the read signal received from the reader, and selects data to be provided in the response. The data may be selected from memory 606. For example, in FIG. 8, memory 606 includes a first data 802, which may any information stored in tag 600 (e.g., an identification number, sensor data, other stored data, etc.).

In step 710, a response to the read signal that includes the data object is transmitted. For instance, modulator 612 receives the selected stored data object from control logic 604 (or directly from memory 606). Modulator 612 transmits the stored data object from an antenna of tag 600 (not shown in FIG. 6). Modulator 612 may transmit the data according to any RFID protocol and in any manner, including in a backscatter manner, depending on the particular tag implementation.

Note that in an embodiment, response enable signal 620 may be used by control logic 604 to select a stored data object from a plurality of stored data objects. In other words, in an enabled condition, response data may be selected from a plurality of data objects, based on a value of response enable signal 620. Thus, in an embodiment, response enable signal 620 may have more than two logical values (e.g., “0” and “1”).

For example, response enable module 610 may have one or more additional comparators than as shown in FIG. 10. Each pair of adjacent comparators may test whether signal strength indication 618 is within a particular range. In an example embodiment, three acceptable ranges may be present, as determined by four comparators. Response enable signal 620 may be a two bit signal, having four values. A “00” logical value for response enable signal 620 may indicate a response is not enabled. The other three logical values, “01”, “10”, and “11”, each indicate that signal strength indication 618 is within one of three acceptable ranges. Thus, for each range, a different response from tag 600 may be appropriate. As shown in FIG. 8, memory 606 includes first data 802, a second data 804, and a third data 806. When response enable signal 620 is “01”, first data 802 may be selected by control logic 604. When response enable signal 620 is “10”, second data 804 may be selected, and when response enable signal 620 is “11”, third data 806 may be selected. Depending on the particular implementation, response enable signal 620 may have any number of possible values.

FIG. 7C shows an additional step for flowchart 700 when a response is not enabled, according to an example embodiment of the present invention. In step 712, a response to the read signal is inhibited based on the measured strength. For example, because signal strength indication 618 is not a desired level, response enable module 610 generates response enable signal 620 to not provide an enable indication (e.g., a “0” logical value). Thus, control logic 604 does not provide output data to modulator 612 and/or does not enable modulator 612 to transmit a response signal.

Note that in an alternative embodiment, when response enable signal 620 indicates that tag 600 is not enabled, control logic 604 may be configured to select a stored dummy data object. The dummy data object may be transmitted from tag 600. In this manner, if a nearby reader receives the dummy data object, this may indicate to the nearby reader a variety of things. In one case, the nearby reader did not attempt to read the tag, but did receive the dummy data object from the tag. Receipt of the dummy data object may indicate to the nearby reader that another reader, including possibly an illicit reader, is attempting to interrogate a nearby tag. If the nearby reader did attempt to interrogate the tag, but received the dummy data object as a response, this may indicate to the reader that the tag is receiving weak or otherwise undesirable signal levels from the reader. Thus, the reader may need to be re-positioned for better reception by the tag.

FIG. 7D shows additional steps for flowchart 700, according to an example embodiment of the present invention, where a time duration is taken into account when generating response enable signal 620. In step 714, a duration of time over which the measured strength is greater than a stored threshold signal strength value is measured. For example, timer 614 measures a duration of time that response enable module 610 measures that signal strength indication 618 is an acceptable value.

In step 716, a response to the read signal is enabled if the measured duration of time is greater than a stored threshold time value. For example, the measured duration of time is compared by response enable module 610 to a threshold time value. For example, as shown in FIG. 8, memory 606 stores a threshold time value 812. Response enable module 610 compares the measured duration of time to threshold time value 812 (e.g., by using a comparator), and if the measured duration of time is greater than threshold time value 812, response enable module 610 generates response enable signal 620 to provide an enable indication. If the measured duration of time is less than threshold time value 812, response enable module 610 generate response enable signal 620 to provide a not enabled indication.

Note that in embodiments, threshold values used by response enable module 610, such as first and second threshold signal strength values 808 and 810, and threshold time value 812, when present, may be hard coded into memory 606. Alternatively, these values may be programmed into memory 606 at a time of manufacture of tag 600, and/or at a later time. For example, memory 606 may be one-time programmable with these values, or these values may be updated at subsequent times, such as by reader communications with tag 600, to account for different readers, different communication environments, etc.

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system (e.g., a reader) using a removable storage drive, hard drive, or communications interface. The control logic (software), when executed by a processor, causes the processor to perform the functions of the invention as described herein.

According to an example embodiment, a reader may execute computer-readable instructions to command a tag to provide a signal strength indication. Furthermore, in an embodiment, a tag may execute computer-readable instructions to monitor a signal strength of a reader transmitted signal and to determine whether a response to a reader communication signal is enabled based on measured signal strength, as further described elsewhere herein.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method in a radio frequency identification (RFID) tag for responding to RFID reader communication signals, comprising:
measuring a strength of a signal from a reader;
receiving a RFID read signal from the reader; and
enabling a response to the read signal based on the measured strength.

2. The method of claim 1, further comprising:
if the response is enabled:
selecting a data object based on the measured signal strength, and
transmitting a response to the read signal that includes the data object.

3. The method of claim 2, wherein said selecting comprises:
selecting a data object from a plurality of data objects based on the measured signal strength.

4. The method of claim 2, wherein said selecting comprises:
selecting a data object if the measured signal strength is greater than a threshold signal strength value.

5. The method of claim 2, wherein said selecting comprises:
selecting a data object if the measured signal strength is less than a threshold signal strength value.

6. The method of claim 2, wherein said selecting comprises:
selecting a data object if the measured signal strength is greater than a first threshold signal strength value and is less than a second threshold signal strength value.

7. The method of claim 1, further comprising:
selecting a dummy data object due to the measured signal strength.

8. The method of claim 1, further comprising:
if the response is not enabled, inhibiting a response to the read signal.

9. The method of claim 1, further comprising:
measuring a duration of time over which the measured strength is greater than a threshold signal strength value.

10. The method of claim 9, wherein said enabling comprises:
enabling a response to the read signal if the measured duration of time is greater than a threshold time value.

11. The method of claim 10, further comprising:
programming the threshold time value into the RFID tag.

12. The method of claim 1, further comprising:
programming a threshold signal strength value into the RFID tag.

13. A radio frequency identification (RFID) tag, comprising:
means for measuring a strength of a signal from a reader;
means for receiving a RFID read signal from the reader; and
means for enabling a response to the read signal based on the measured strength.

14. A radio frequency identification (RFID) tag, comprising:
an antenna;
a signal strength monitor module configured to measure a strength of a signal received at the antenna from a reader;
a demodulator configured to receive a RFID read signal from the reader; and
a response enable module configured to enable a response to the read signal based on the measured strength.

15. The RFID tag of claim 14, further comprising:
a modulator coupled to the antenna;
wherein the modulator is configured to modulate a response to the read signal onto a radio frequency signal if enabled by the response enable module.

16. The RFID tag of claim 14, further comprising:
a substrate; and
an integrated circuit (IC) die mounted to the substrate, wherein the signal strength monitor module, demodulator, and response enable module are in the IC die;
wherein the antenna is formed on the substrate.

17. The RFID tag of claim 14, wherein the response enable module is configured to enable selection of a stored data object based on the measured signal strength.

18. The RFID tag of claim 14, wherein the response enable module comprises a comparator that compares the measured signal strength to a threshold signal strength value.

19. The RFID tag of claim 14, wherein the response enable module is configured to enable selection of a stored data object from a plurality of stored data objects based on the measured signal strength.

20. The RFID tag of claim 14, wherein the response enable module is configured to enable selection of a stored data object if the measured signal strength is greater than a stored threshold signal strength value.

21. The RFID tag of claim 14, wherein the response enable module is configured to enable selection of a stored data object if the measured signal strength is less than a stored threshold signal strength value.

22. The RFID tag of claim 14, wherein the response enable module is configured to enable selection of a stored data object if the measured signal strength is greater than a stored threshold signal strength value.

23. The RFID tag of claim 14, wherein the response enable module is configured to enable selection of a stored data object if the measured signal strength is greater than a first stored threshold signal strength value and is less than a second stored threshold signal strength value.

24. The RFID tag of claim 14, wherein the response enable module is configured to enable selection of a stored dummy data object based on the measured signal strength.

25. The RFID tag of claim 14, wherein the response enable module is configured to inhibit a response to the read signal based on the measured strength.

26. The RFID tag of claim 14, further comprising:
a timer module configured to measure a duration of time over which the measured strength is greater than a stored threshold signal strength value.

27. The RFID tag of claim 26, wherein the response enable module is configured to enable a response to the read signal if the measured duration of time is greater than a stored threshold time value.

28. The RFID tag of claim 27, further comprising:
a memory that stores the threshold time value.

29. The RFID tag of claim 14, further comprising:
a memory that stores a threshold signal strength value.
